(19) United States
(12) Patent Application Publication
(10) Pub. No.: US 2026/0010741 A1
(43) Pub. Date: Jan. 8, 2026

(54) COMPUTING TECHNOLOGIES FOR USING LANGUAGE MODELS TO IMPROVE MACHINE TRANSLATIONS FOR PROPER USAGE OF TERMINOLOGY AND GENDER

(71) Applicant: Smartling, Inc., New York, NY (US)

(72) Inventors: Mei Chai Zheng, New York, NY (US); Benjamin Loy, New York, NY (US)

(21) Appl. No.: 19/323,204

(22) Filed: Sep. 9, 2025

Related U.S. Application Data
(63) Continuation of application No. PCT/US2024/019090, filed on Mar. 8, 2024.
(60) Provisional application No. 63/451,452, filed on Mar. 10, 2023.

(51) Int. Cl. G06F 40/58; G06F 40/284; G06F 40/51

(52) U.S. Cl. CPC G06F 40/58; G06F 40/284; G06F 40/51

(57) ABSTRACT

This disclosure solves various technological problems described above by using large language models to improve machine translations for proper usage of terminology, gender, or other suitable predetermined linguistics. Such improvements may be manifested by resolution of certain grammar, morphology, or other linguistic issues in machine-translation outputs incorporating specific terminology, such as brand names and gendered terms, as disclosed herein.

### CROSS-REFERENCE TO RELATED PATENT APPLICATIONS

This patent application is a Continuation of a PCT International Application PCT/US2024/019090 filed 8 Mar. 2024; which claims a benefit of priority to U.S. Provisional Patent Application 63/451,452 filed 10 Mar. 2023; each of which is incorporated by reference herein for all purposes.

### TECHNICAL FIELD

This disclosure relates to large language models.

### BACKGROUND

Conventionally, many people use machine translation (MT) engines operating based on generic MT models to create generic translations (e.g., from Russian language to English language). In such translations, these MT models typically employ term replacement (e.g., swapping or substitution) to favor one type of terminology and bias in gender of titles (e.g., a doctor, a professor, a governor) and nouns, while also being difficult, complicated, laborious, or impossible to be easily customized to provide a high-level of MT quality (e.g., on professional level) to end users. This state of being leaves little room for customized translations through MT models and requires many end users to invest resources (e.g., time, money, equipment) to ensure that content being translated has a proper integration of terminology and gender through usage of trained linguists that need to review all relevant translated content. Therefore, these MT engines suffer from various technical problems with terminology translation, gender translation, and corresponding suitable replacement when MT is used.

With respect to terminology translation, some users desire a specific terminology (e.g., a professional title, a governmental position, a company name) in a source sentence to be reflected in a specific way in a translation thereof. Historically, this does not work well, because some natural language words are interdependent and each language has its own unique grammatical rules and properties. For example, updating a noun or a noun phrase from a glossary into a language with a presence of gender or morphology for nouns will result in a grammatically incorrect sentence if (1) a replacement for the noun or the noun phrase results in a gender mismatch between an article and the noun or the noun phrase, or the article or a modifying adjective and the noun or the noun phrase, or (2) a replacement for the noun or the noun phrase results in the noun or the noun phrase and surrounding verbs or noun inflection mismatch (e.g., due to gender, case inflection, number inflection in singular versus plural forms). Additionally, some terminology bases are currently developed for various human use cases, where a human is able to gather more context to be better informed on usage of specific terms and phrases in a proper manner. This approach may be applicable when (1) finding words to translate or not translate is difficult (e.g., selecting a correct word as well as a proper translation in a corresponding language), (2) placing a word in a translation string can cause a resulting translation to have incorrect grammar, poor understandability, poor fluency, incorrect morphology, or incorrect sentence structure, or (3) replacing a phrase often breaks a structure of a sentence or word ordering to influence meaning or add ambiguity to meaning. As such, conventional approaches for term replacement in MT engines are limited and often are unable to solve some, many, most, or all of these technical problems when working with terms, because these MT engines may use (1) a replacement process that ignores a morphology of a sentence during a translation process or (2) a “blind search and replace” approach to identifying a term that should be replaced with a given term.

With respect to gender translation, many languages have gendered nouns and titles (e.g., a doctor, a lawyer, a military rank) that come in forms of masculine and feminine. Some MT engines will often assume masculine nouns and titles, due to biased training sets that often use these terms in the masculine form by default when no gender is specified. There is currently no known possibility of indicating if a noun or title should be masculine or feminine, causing some output from these MT engines to be incorrect in some cases. Such state of being may be based on specific terminology in specific languages being neutral, while for other languages, there are gender specific versions, which may be generally applicable to professions or titles (e.g. a doctor, a governor, a mayor). Notably, in some use cases, when referencing a person by their professional title, a sole way to properly translate a title of that person to a right gender may be through context awareness of an original content, which may not often be known by a respective MT engine. For example, when presented a document (e.g., an article) where a person, who is a doctor, is referred to as a female in a female form in a beginning section of the document, some MT engines are unable to continue to recognize that need to use the female form of doctor through from that point on, other than in exception cases where context is provided in that same string or a first name is presented with a specific expected gender for that name (e.g., Kevin is usually male and Samantha is usually female). Additionally, if a last name is alone in conjunction with a professional title (e.g., a military rank, a professor), then some MT engines may not easily derive gender based on the last name alone, even though such usage would be clear to a natural speaker of that language (e.g., Russian). Likewise, since some first names can be used for both genders (e.g., Alex, Ariel), some MT engines may be inaccurate to determine a gender on a basis of a first name alone. Therefore, some MT engines are not ideal for translating languages, where gender needs to be taken into consideration as part of a translation output, as those MT engines do not understand such differences. For example, some MT engines may not correctly distinguish between gender specific terms or phrases, if there is no indication thereof in source content. Likewise, some MT engines may default to male forms, if no guidance is given through pronouns and gendered titles in content. Similarly, some MT engines may be biased towards specific genders (e.g., male forms are output). Moreover, some MT engines may not allow its input to specify gender forms. Additionally, some MT engines may not output possible gender neutral formation of normally gendered terms (e.g., chairperson instead of chairman or chairwoman).

### SUMMARY

This disclosure solves various technological problems described above by using large language models (LLMs) to improve MTs for proper usage of terminology, gender, or other suitable predetermined linguistics. Such improvements may be manifested by resolution of certain grammar, morphology, or other linguistic issues in MT outputs incorporating specific terminology, such as brand names and gendered terms, as disclosed herein. Resultantly, these improvements improve computer functionality and text processing.

There may be an embodiment comprising a system programmed as described herein. For example, the system may comprise: a computing instance programmed to: (i) submit a source text to a network-based MT service, such that the network-based MT service outputs a target text translated from the source text; (ii) determine whether the target text satisfies a condition; (iii) determine whether a first term is not present in the target text, responsive to the condition being determined to be satisfied; (iv) submit the first term and the target text to an LLM, such that the LLM outputs the target text modified to contain the first term, responsive to the first term being determined to be not present in the target text; (v) determine whether a second term is present in the target text (a) unmodified in content as output from the network-based MT service or (b) modified via the LLM to contain the first term; and (vi) submit the second term and the target text (a) unmodified in content as output from the network-based MT service or (b) modified via the LLM to contain the first term to the LLM, such that the LLM outputs the target text (a) unmodified in content as output from the network-based MT service or (b) modified via the LLM to contain the first term, modified to contain the second term in a grammatically correct manner or a morphologically correct manner, responsive to the second term being determined to be present in the target text (a) unmodified in content as output from the network-based MT service or (b) modified via the LLM to contain the first term.

There may be an embodiment comprising a method programmed as described herein. For example, the method may comprise: (i) submitting, via a computing instance, a source text to a network-based MT service, such that the network-based MT service outputs a target text translated from the source text; (ii) determining, via the computing instance, whether the target text satisfies a condition; (iii) determining, via the computing instance, whether a first term is not present in the target text, responsive to the condition being determined to be satisfied; (iv) submitting, via the computing instance, the first term and the target text to an LLM, such that the LLM outputs the target text modified to contain the first term, responsive to the first term being determined to be not present in the target text; (v) determining, via the computing instance, whether a second term is present in the target text (a) unmodified in content as output from the network-based MT service or (b) modified via the LLM to contain the first term; and (vi) submitting, via the computing instance, the second term and the target text (a) unmodified in content as output from the network-based MT service or (b) modified via the LLM to contain the first term to the LLM, such that the LLM outputs the target text (a) unmodified in content as output from the network-based MT service or (b) modified via the LLM to contain the first term, modified to contain the second term in a grammatically correct manner or a morphologically correct manner, responsive to the second term being determined to be present in the target text (a) unmodified in content as output from the network-based MT service or (b) modified via the LLM to contain the first term.

There may be an embodiment comprising a storage medium programmed as described herein. For example, the storage medium may store a set of instructions executable by a computing instance to perform a method, wherein the method may comprise: (i) submitting, via a computing instance, a source text to a network-based MT service, such that the network-based MT service outputs a target text translated from the source text; (ii) determining, via the computing instance, whether the target text satisfies a condition; (iii) determining, via the computing instance, whether a first term is not present in the target text, responsive to the condition being determined to be satisfied; (iv) submitting, via the computing instance, the first term and the target text to an LLM, such that the LLM outputs the target text modified to contain the first term, responsive to the first term being determined to be not present in the target text; (v) determining, via the computing instance, whether a second term is present in the target text (a) unmodified in content as output from the network-based MT service or (b) modified via the LLM to contain the first term; and (vi) submitting, via the computing instance, the second term and the target text (a) unmodified in content as output from the network-based MT service or (b) modified via the LLM to contain the first term to the LLM, such that the LLM outputs the target text (a) unmodified in content as output from the network-based MT service or (b) modified via the LLM to contain the first term, modified to contain the second term in a grammatically correct manner or a morphologically correct manner, responsive to the second term being determined to be present in the target text (a) unmodified in content as output from the network-based MT service or (b) modified via the LLM to contain the first term.

There may be an embodiment comprising a system programmed as described herein. For example, the system may comprise: a computing instance programmed to: (i) submit a source text to a network-based MT service, such that the network-based MT service outputs a target text translated from the source text; (ii) determine whether the target text satisfies a condition; (iii) determine whether the target text lacks a first term and has a second term, responsive to the condition being determined to be satisfied; (iv) based on the target text being determined to lack the first term and have the second term: generate a prompt reciting the first term and the second term; and submit the prompt to an LLM, such that the LLM outputs a modification of the target text to include the first term and the second term in a grammatically correct manner or a morphologically correct manner.

There may be an embodiment comprising a method programmed as described herein. For example, the method may comprise: (i) submitting, via a computing instance, a source text to a network-based MT service, such that the network-based MT service outputs a target text translated from the source text; (ii) determining, via the computing instance, whether the target text satisfies a condition; (iii) determining, via the computing instance, whether the target text lacks a first term and has a second term, responsive to the condition being determined to be satisfied; (iv) based on the target text being determined to lack the first term and have the second term: generating, via the computing instance, a prompt reciting the first term and the second term; and submitting, via the computing instance, the prompt to an LLM, such that the LLM outputs a modification of the target text to include the first term and the second term in a grammatically correct manner or a morphologically correct manner.

There may be an embodiment comprising a storage medium programmed as described herein. For example, the storage medium may store a set of instructions executable by a computing instance to perform a method, wherein the method may comprise: (i) submitting, via a computing instance, a source text to a network-based MT service, such that the network-based MT service outputs a target text translated from the source text; (ii) determining, via the computing instance, whether the target text satisfies a condition; (iii) determining, via the computing instance, whether the target text lacks a first term and has a second term, responsive to the condition being determined to be satisfied; (iv) based on the target text being determined to lack the first term and have the second term: generating, via the computing instance, a prompt reciting the first term and the second term; and submitting, via the computing instance, the prompt to an LLM, such that the LLM outputs a modification of the target text to include the first term and the second term in a grammatically correct manner or a morphologically correct manner.

### DESCRIPTION OF DRAWINGS

FIG. 1 shows a diagram of an embodiment of a computing architecture according to this disclosure.

FIG. 2 shows a flowchart of an embodiment of an algorithm for a translation according to this disclosure.

FIG. 3 shows a table of an embodiment of a data structure for a glossary according to this disclosure.

FIG. 4 shows a diagram of an embodiment of a hierarchy for a glossary according to this disclosure.

FIG. 5 shows a flowchart of an embodiment of an algorithm for a validation according to this disclosure.

FIG. 6 shows a flowchart of an embodiment of an algorithm for a translation according to this disclosure.

### DETAILED DESCRIPTION

As explained above, this disclosure solves various technological problems described above by using LLMs to improve machine translations for proper usage of terminology, gender, or other suitable predetermined linguistics. Such improvements may be manifested by resolution of certain grammar, morphology, or other linguistic issues in MT outputs incorporating specific terminology, such as brand names and gendered terms, as disclosed herein. This disclosure is now described more fully with reference to all attached figures, in which some embodiments of this disclosure are shown. This disclosure may, however, be embodied in many different forms and should not be construed as necessarily being limited to various embodiments disclosed herein. Rather, these embodiments are provided so that this disclosure is thorough and complete, and fully conveys various concepts of this disclosure to skilled artisans. Note that like numbers or similar numbering schemes can refer to like or similar elements throughout.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

As used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of the foregoing instances. For example, X includes A or B can mean X can include A, X can include B, and X can include A and B, unless specified otherwise or clear from context.

As used herein, each of singular terms “a,” “an,” and “the” is intended to include a plural form (e.g., two, three, four, five, six, seven, eight, nine, ten, tens, hundreds, thousands, millions) as well, including intermediate whole or decimal forms (e.g., 0.0, 0.00, 0.000), unless context clearly indicates otherwise. Likewise, each of singular terms “a,” “an,” and “the” shall mean “one or more,” even though a phrase “one or more” may also be used herein.

As used herein, each of terms “comprises,” “includes,” or “comprising,” “including” specify a presence of stated features, integers, steps, operations, elements, or components, but do not preclude a presence or addition of one or more other features, integers, steps, operations, elements, components, or groups thereof.

As used herein, when this disclosure states herein that something is “based on” something else, then such statement refers to a basis which may be based on one or more other things as well. In other words, unless expressly indicated otherwise, as used herein “based on” inclusively means “based at least in part on” or “based at least partially on.”

As used herein, terms, such as “then,” “next,” or other similar forms are not intended to limit an order of steps. Rather, these terms are simply used to guide a reader through this disclosure. Although process flow diagrams may describe some operations as a sequential process, many of those operations can be performed in parallel or concurrently. In addition, the order of operations may be re-arranged.

As used herein, a term “response” or “responsive” are intended to include a machine-sourced action or inaction, such as an input (e.g., local, remote), or a user-sourced action or inaction, such as an input (e.g., via user input device).

As used herein, a term “about” or “substantially” refers to a +/−10% variation from a nominal value/term.

As used herein, a term “locale” refers to a standard language locale definition but where a language identifier (e.g., en, es) is required and a region identifier (e.g., US, ES) is optional.

Although various terms, such as first, second, third, and so forth can be used herein to describe various elements, components, regions, layers, or sections, note that these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section, without departing from this disclosure.

Unless otherwise defined, all terms (including technical and scientific terms) used herein have the same meaning as commonly understood by skilled artisans to which this disclosure belongs. These terms, such as those defined in commonly used dictionaries, should be interpreted as having a meaning that is consistent with their meaning in context of relevant art and should not be interpreted in an idealized or overly formal sense, unless expressly so defined herein.

Features or functionality described with respect to certain embodiments may be combined and sub-combined in or with various other embodiments. Also, different aspects, components, or elements of embodiments, as disclosed herein, may be combined and sub-combined in a similar manner as well. Further, some embodiments, whether individually or collectively, may be components of a larger system, wherein other procedures may take precedence over or otherwise modify their application. Additionally, a number of steps may be required before, after, or concurrently with embodiments, as disclosed herein. Note that any or all methods or processes, as disclosed herein, can be at least partially performed via at least one entity or actor in any manner.

Hereby, all issued patents, published patent applications, and non-patent publications that are mentioned or referred to in this disclosure are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

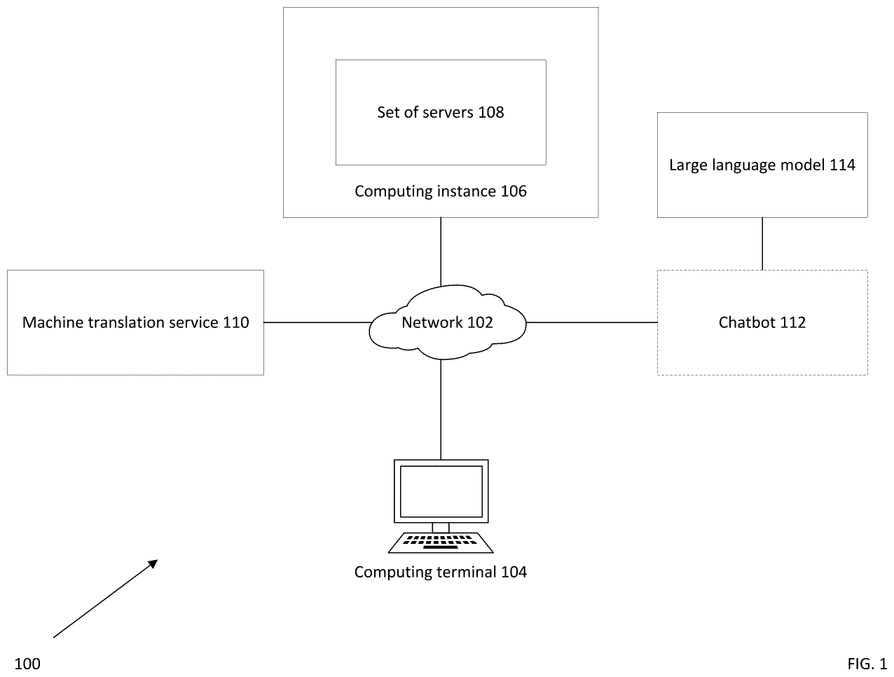

FIG. 1 shows a diagram of an embodiment of a computing architecture according to this disclosure. In particular, there is a computing architecture 100 containing a network 102, a computing terminal 104, a computing instance 106, an MT service 110, a chatbot 112, and an LLM 114. The computing instance 106 contains a server or set of servers 108. The chatbot 112 is optional and may be omitted.

The network 102 is a wide area network (WAN), but may be a local area network (LAN), a cellular network, a satellite network, or any other suitable network. For example, the network 102 is Internet. Although the network 102 is illustrated as a single network 102, this configuration is not required and the network 102 can be a group or collection of suitable networks collectively operating together in concert to accomplish various functionality, as disclosed herein.

The computing terminal 104 is a desktop computer, but may be a laptop computer, a tablet computer, a wearable computer, a smartphone, or any other suitable computing form factor. The computing terminal 104 hosts an operating system (OS) and an application program on the OS. For example, the OS may include Windows, MacOS, Linux, or any other suitable OS. Likewise, the application program may be a browser program (e.g., Microsoft Edge, Apple Safari, Mozilla Firefox), an enterprise content management (ECM) program, a content management system (CMS) program, a customer relationship management (CRM) program, a marketing automation platform (MAP) program, a product information management (PIM) program, and a translation management system (TMS) program, or any other suitable application, which is operable (e.g., interactable, navigable) by a user of the computing terminal 104. The computing terminal 104 may be in communication (e.g., wired, wireless, waveguide) with the computing instance 106, the MT service 110, the chatbot 112, or the LLM 114 over the network 102. For example, such communication may occur via the application program running on the OS, as explained above. The computing terminal 102 is separate and distinct from the computing instance 106, the MT service 110, the chatbot 112, or the LLM 114.

The computing instance 106 is a computing service or unit containing the server (e.g., physical or virtual) or the set of servers 108 (e.g., physical or virtual) programmatically acting in concert, any of which may be a web server, an application server, a database server, or another suitable server, to enable various algorithms disclosed herein. For example, via the server or the set of servers 108, the computing instance 106 may be enabled in a cloud computing service (e.g., Amazon Web Services (AWS)) as a service-oriented-architecture (SOA) backend technology stack having a plurality of services that are interconnected via various application programming interfaces (APIs), to enable various algorithms disclosed herein, any of which may be internal or external to the computing instance 106. For example, some of such APIs may have, call, or instantiate representational state transfer (REST) or RESTful APIs integrations or some of services may have, instantiate, or call some data sources (e.g., databases, relational databases, database services, relational database services, graph databases, in-memory databases, RDS, S3, Kafka) to persist data, as needed, whether internal to the computing instance 106 or external to the computing instance 106, to enable various algorithms disclosed herein. For example, the computing instance 106 may host or run an application program, which may be distributed, on the SOA hosting, deploying, calling, or accessing the services that are interconnected via the APIs, to enable various algorithms disclosed herein. For example, the computing instance 106 (e.g., an application program) may have, host, call, or instantiate a glossary service (e.g., a term base containing terms specified by a user), whether internal to the computing instance 106 or external to the computing instance 106, to enable various algorithms disclosed herein. For example, the glossary service may have, call, or instantiate a cloud service, whether internal or external to the computing instance 106, that has a database (e.g., relational, graph, in-memory, NoSQL), whether internal or external to the computing instance 106, containing a multilingual terminology for a set of users requesting translations, whether internal to the computing instance 106 or external to the computing instance 106, to enable various algorithms disclosed herein. The cloud service may have a number of REST APIs to execute create, update, read, and delete (CRUD) operations to maintain the database and a number of other APIs to do tasks involving taking text and returning terms that are present within a text (e.g., unstructured, structured) being translated and return translations of those terms, to enable various algorithms disclosed herein. The glossary service may include glossary unique identifiers (UIDs) to partition certain glossary terms into different content groups that can be accessed independently of each other, to enable various algorithms disclosed herein. The computing instance 106 may be in communication (e.g., wired, wireless, waveguide) with the computing terminal 104, the MT service 110, the chatbot 112, or the LLM 114 over the network 102. For example, such communication may occur via the SOA) backend technology stack or the glossary service, as explained above. The computing instance 106 is separate and distinct from the computing terminal 104, the MT service 110, the chatbot 112, or the LLM 114. However, such configurations may vary. For example, the computing instance 106 may internally host the MT service 110, the chatbot 112, or the LLM 114.

The MT service 110 is a network-based MT service that instantly translates words, phrases, and web pages between at least two languages (e.g., English and Hebrew). For example, the MT service 110 may be running on a server or a set of servers (e.g., physical or virtual) acting in concern to host an MT engine (e.g., a task-dedicated executable logic that can be started, stopped, or paused) having a neural machine translation (NMT) logic. For example, the MT service 110 may be Google Translate, Bing Translator, Yandex Translate, or another suitable network-based MT service. The MT service 110 may be in communication (e.g., wired, wireless, waveguide) with the computing terminal 104, the computing instance 106, the chatbot 112, or the LLM 114 over the network 102. For example, such communication may occur via the MT engine, as explained above. The MT service 110 is separate and distinct from the computing terminal 104, the computing instance 106, the chatbot 112, or the LLM 114. However, such configurations may vary. For example, the MT service 110 may internally host the computing instance 106, the chatbot 112, or the LLM 114.

The chatbot 112 is a computer program that simulates human conversation, allowing interaction through text or voice. The chatbot 112 can handle various tasks, which may range from answering customer queries to providing support or automating processes. The chatbot 112 can be a scripted or quick reply chatbot, a keyword recognition-based chatbot, a hybrid chatbot, a contextual chatbot, a voice chatbot, or another suitable chatbot form factor. For example, the chatbot 112 may be ChatGPT, Google Gemini, Microsoft Copilot, or another suitable chatbot. The chatbot 112 may be in communication (e.g., wired, wireless, waveguide) with the computing terminal 104, the computing instance 106, the MT service 110, or the LLM 114 over the network 102. The chatbot 112 is separate and distinct from the computing terminal 104, the computing instance 106, the MT service 110, or the LLM 114. However, such configurations may vary. For example, the chatbot 112 may directly communicate with the LLM 114 or internally host the LLM 114, to be operated thereby. Alternatively, the LLM 114 may directly communicate with the chatbot 112 or internally host the chatbot 112, to enable the chatbot 112 to be operated thereby. Additionally, the computing instance 106 or the MT service 110 may internally host the chatbot 112, whether the chatbot 112 is separate and distinct from the LLM 114 or not, as explained above. Note that the chatbot 112 is optional and may be omitted.

The LLM 114 may be a language model (e.g., a generative artificial intelligence (AI) model, a generative adversarial network (GAN) model, a generative pre-trained transformer (GPT) model) including an artificial neural network (ANN) with a set of parameters (e.g., tens of weight, hundreds of weights, thousands of weights, millions of weights, billions of weights, trillions of weights), initially trained on a quantity of unlabeled content (e.g., text, unstructured text, descriptive text, imagery, sounds) using a self-supervised learning algorithm or a semi-supervised learning algorithm to understand a set of corresponding data relationships. Then, the LLM 114 may be further trained by fine-tuning or refining the set of corresponding data relationships via a supervised learning algorithm or a reinforcement learning algorithm. Once the LLM 114 is trained, the LLM 114 is structured to have a data structure and organized to have a data organization. As such, the data structure and the data organization collectively enable the LLM 114 to perform various algorithms disclosed herein. For example, the LLM 114 may be a general purpose model, which may excel at a range of tasks (e.g., generating a content for a user consumption) and may be prompted, i.e., programmed to receive a prompt (e.g. a request, a command, a query), to do something or accomplish a certain task. The LLM 114 may be embodied as or accessible via a ChatGPT AI chatbot, a Google Gemini AI chatbot, or another suitable LLM. The LLM 114 may be prompted by the computing terminal 104, the computing instance 106, or the MT service 110, whether directly or indirectly. For example, the computing instance 106 may be programmed to engage with the LLM 114 over the network 102, whether through the chatbot 112 or without the chatbot 112, to perform various algorithms disclosed herein. Alternatively, the computing instance 106 may internally host the LLM 114 and programmed to engage with the LLM 114, to perform various algorithms disclosed herein. Such forms of engagement may include inputting a text (e.g., structured or unstructured) into the LLM 114 in a human-readable form, for the LLM 114 to output a content (e.g., a text, an unstructured text, a descriptive text, an image, a sound), i.e., to do something or accomplish a certain task.

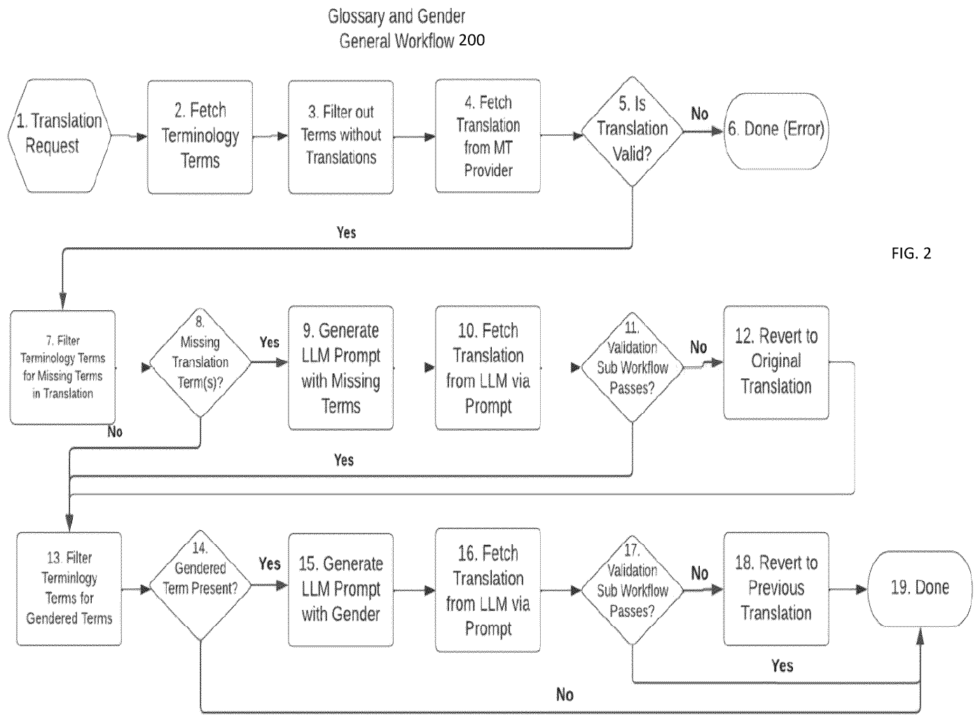

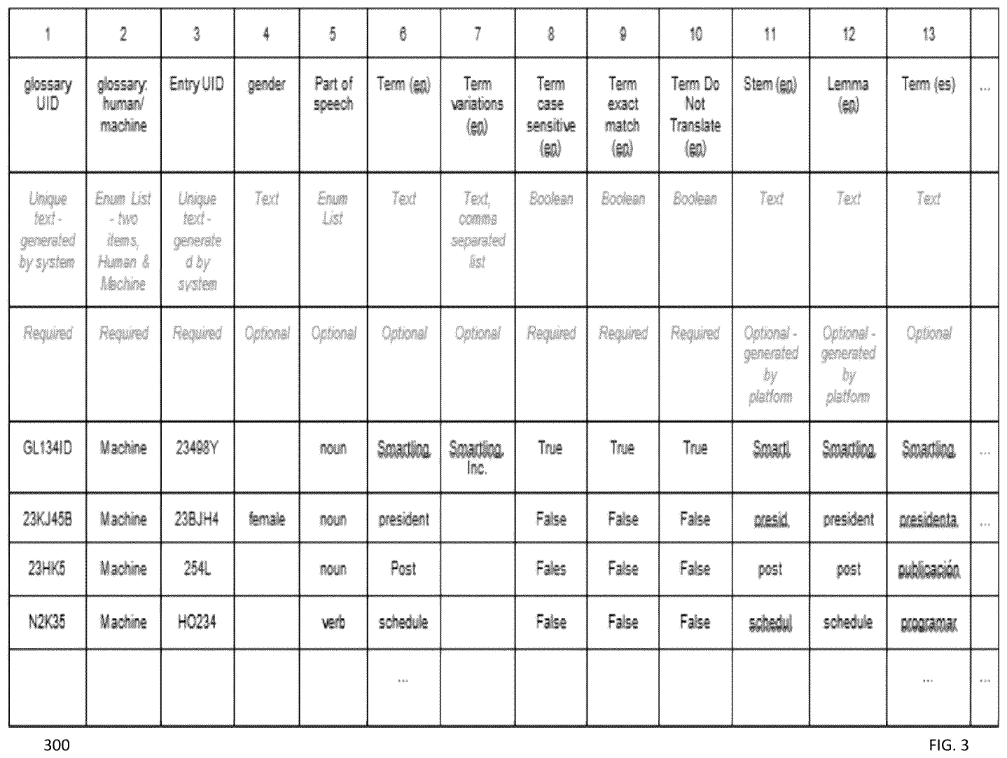

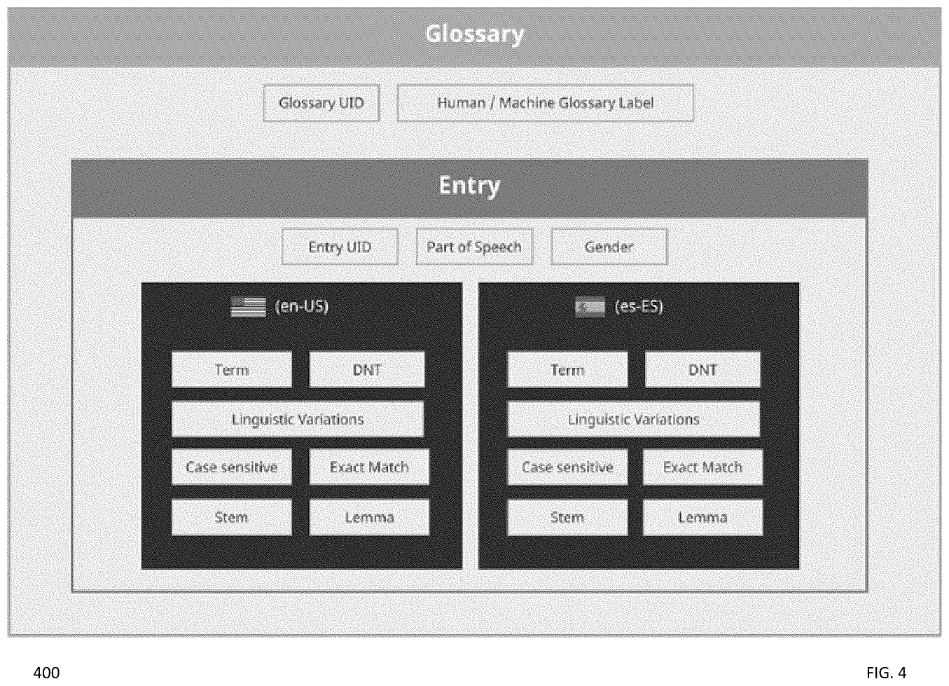

FIG. 2 shows a flowchart of an embodiment of an algorithm for a translation according to this disclosure. FIG. 3 shows a table of an embodiment of a data structure for a glossary according to this disclosure. FIG. 4 shows a diagram of an embodiment of a hierarchy for a glossary according to this disclosure. In particular, a method 200 enables an algorithm for a translation using the computing architecture 100 of FIG. 1, a data structure 300 for a glossary of FIG. 3, and a hierarchy 400 for a glossary of FIG. 4. The method 200, the data structure 300, and the hierarchy 400 collectively improve MTs for proper usage of terminology, gender, or other suitable predetermined linguistics. Such improvements may be manifested by resolution of certain grammar, morphology, or other linguistic issues in MT outputs incorporating specific terminology, such as brand names and gendered terms, as disclosed herein. Resultantly, these improvements improve computer functionality and text processing.

The method 200 has steps 1-19, which may be performed by the computing instance 106 (e.g., an application program). As such, in order to ensure proper replacement of terms, gendered terms, or other suitable linguistics, the computing instance 106 is programmed to grammatically correct and smooth sentences based on information provided and terms, key word, or gender changes, where the computing instance 106 (e.g., an application program) may perform steps 1-19, as further explained below. Some of these operations may involve linguistic tokenization (e.g., splitting text into words or parts of a word in order to analyze, classify, and process the words to transform a text accordingly), stemming (e.g., identifying a root of a word through removal/reduction of a word performed through specific stemming services), lemmatization (e.g., morphological analysis of a word to remove things like inflectional endings to return a base form of a word), or other linguistic operations. Note that a green arrow respectfully corresponds to a positive response from a step, while a red arrow respectfully corresponds to a negative response from a step.

Step 1 involves the computing instance 106 receiving a translation request from the computing terminal 104 over the network 102. The translation request includes a source text, a source locale identifier (ID), a target locale ID, a set of MT provider credentials and metadata, and a set of glossary unique identifiers (UIDs). For example, the source text may be an original text that needs to be translated, the target text may be an output text that has been translated from the source text, the source or target local may include language and regional information, such as Spanish for Mexico (es-MX), and the source or target ID may be an International Standards Organization (ISO) code to define and determine a locale.

The source text may be structured, such as a JavaScript Objection Notation (JSON) content, an eXtensible Markup Language (XML) content, a Darwin Information Typing Architecture (DITA) content, or another suitable structured content. The source text may be unstructured, such as descriptive content, natural language content, or any other suitable unstructured content. The source text is an input text to be translated. For example, the input text may include an unstructured text or descriptive text (e.g., an article, a legal document, a patent specification) contained in a data structure (e.g., a file, a data file, a text file, an email message).

The source locale ID may be a modified ISO-639 (or another standard) language code (e.g., en, es) and a modified ISO-3166 country code (e.g., US, ES) representing a source text locale (e.g., ru-RU).

The target locale ID may be a modified ISO-639 (or another standard) language code (e.g., en, es) and a modified ISO-3166 country code (e.g., US, US) representing a desired locale to use for translation (e.g., en-US).

The set of MT provider credentials and metadata may include a name of a MT service provider to use (e.g., Google MT engine, Microsoft MT engine, DeepL MT engine) by the computing instance 106. For example, the name of the MT service provider may be identified by an identifier (e.g., an alphanumeric string). The set of MT provider credentials and metadata may include a set of MT service provider credentials to interact with the MT service provider (e.g., a login and a password). The set of MT provider credentials and metadata may include a set of MT service provider specific metadata to control various aspects of a translation process (e.g., a custom model).

The set of glossary UIDs may be used by the computing instance 106 to determine which glossary data structures (e.g., a database, a table, a record, a field, an array, a tree, a graph) to use by the computing instance 106 for generating glossary terms by the computing instance 106. For example, one glossary data structure may be for Spanish language and another glossary data structure may be for Hebrew language. For example, one glossary data structure may be for one type of content (e.g., industry, formality, marketing, life science, computing, legal) and another glossary data structure may be for another type of content (e.g., industry, formality, marketing, life science, computing, legal). Each glossary data structure (e.g., a database, a table, an array, a tree) may contain a set of glossary terms in multiple languages (e.g., Russian and English).

One example of a glossary data structure is shown in FIG. 3 as the data structure 300 showing relevant fields used in the method of FIG. 2. Columns 6-12 are repeated per specified locale that is present in the data structure 300 based on desired translation needs, but can vary or be adapted for any languages (e.g., English, Spanish, French, Russian, German, Italian, Greek, Azeri, Armenian, Georgian, Turkish, Hebrew, Arabic, Mandarin, Cantonese, Urdu, Bengali). The data structure 300 has various data points, which may be organized (e.g., related to each other) via a primary key for use by the computing instance 106. The glossary UID field contains is a unique identifier generated by the computing instance 106 to identify a specific glossary. For example, the glossary UID may be a primary key by which other data points are accessible. The glossary human/machine field contains a label to identify if a specific glossary is made for use in a manual translation (e.g., by a human translator) or a MT. The entry UID field contains a unique identifier generated by the computing instance 106 to identify a specific entry (item) in the data structure 300. The part of speech field contains a label of a part of speech for an entry. The gender field contains a gender label for an entry if applicable. The term (en) field contains a specific term for an entry in specified locale (en-US). Note that such selection of a language is illustrative and can vary based on a desired translation. Likewise, note that such field may sometimes be omitted, because for each entry, there only needs to be a term present in one of two locales for a desired translation. The term variations/linguistic variations (en) field contains a set of possible variations of that term in a specified locale (e.g. en-UK). Again, similar to above, note that such selection of a language is illustrative and can vary based on a desired translation. The term case sensitive (en) field contains a value defining for the computing instance 106 if that term in the source text should be an exact match including case sensitivity and should not match any potentially associated terms found based on stemming of that term. For example, “interview” marked as an exact match will only look for “interview”, but not “Interview”, “interviews”, “interviewing”, or “interviewed.” Again, similar to above, note that such selection of a language is illustrative and can vary based on a desired translation. The term exact match (en) field contains a value defining for the computing instance 106 if that term in the source text should be an exact match and not any potentially associated terms found based on the stemming of that term. For example, “interview” marked as an exact match will only look for “interview” or “Interview”, but not “interviews”, “interviewing”, or “interviewed”. Again, similar to above, note that such selection of a language is illustrative and can vary based on a desired translation. The term do not translate (en) filed contains a value defining for the computing instance 106 if that term found in the source text side should not be translated. For example, do not translate may be abbreviated as DNT or another suitable label. Again, similar to above, note that such selection of a language is illustrative and can vary based on a desired translation. The stem (en) field contains a stem of a term from a stemming network-based service (e.g., a data source or an API whether internal or external to the computing instance 106) for a specified locale (e.g., en-US). This field is used by the computing instance 106 in case when not looking for an exact match or case sensitive term. Again, similar to above, note that such selection of a language is illustrative and can vary based on a desired translation. The lemma (en) field contains a lemma of a term from a lemmatization service (e.g., a data source or an API whether internal or external to the computing instance 106) for a specified locale (e.g., en-US). This field is used by the computing instance 106 in case when not looking for an exact match or case sensitive term. Again, similar to above, note that such selection of a language is illustrative and can vary based on a desired translation. As such, the data structure 300 showing relevant fields used in the method of FIG. 2 may be exemplified in FIG. 3 showing an example diagram of a hierarchy of a glossary, entry and terms per locale, according to FIG. 2 and FIG. 1. Some other examples of glossaries can be found here: https://help.smartling.com/hc/en-us/articles/12026027210139-Elements-of-a-Glossary-Entry, which is incorporated by reference herein for all purposes.

Step 2 involves the computing instance 106 fetching of terminology terms. This may occur by the computing instance 106 making a call to an API (e.g., a REST API) to the glossary service with the source text, the source locale ID, the target locale ID, and the list of glossary UIDs (e.g., one UID for source language glossary and one UID for target language glossary). In reply, the computing instance 106 receives a response from the API, where the response contains zero or more terms that are present in the source text. These terms may overlap, be unique, or have different versions for different parts of speech. These terms may contain, a term text in a source language, an optional term text in a target language, an optional gender form for a term text, or an optional part-of-speech (PoS)-Tag for the term text. At that time, the response (e.g., a collection of terms) may be passed to a next step. If there is an error with the call to the API, then the method 200 may continue with an empty collection of terms.

Step 3 involves the computing instance 106 filtering out terms without translations. These operations may remove invalid terms for this particular case. For example, these operations may include the computing instance 106 remove or ignore terms that do not have translation term text, such as when terms may not be translatable from the source language to the target language. Likewise, these operations may include the computing instance 106 tokenize the source text (e.g., by words, terms, phrases). Similarly, these operations may include the computing instance 106 use a part-of-speech (POS) tagger (e.g., a function, a service, a subroutine) to label a set of tokens as their respective parts of speech. If a term has a POS defined and the POS doesn't match the POS defined by the POS tagger, then the computing instance 106 may remove or ignore the term.

Step 4 involves the computing instance 106 fetching a translation from the MT service 110. These operations may include calling the MT service 110 that corresponds to the name of the MT service provider in the input (e.g., based on identifier). Note there may be multiple MT services 110, each configured differently from others, or operated by different entities. In response, the MT service 110 may execute various forms of transformations on the source text that is appropriate for the MT service 110. These transformations may include (i) escaping the source text characters to be in a proper content type format for the MT service 110 (e.g., hypertext markup language (HTML)), (ii) splitting the source text based on length and text characteristics, like tags, punctuation, and sentence delimiters, (iii) identifying portions of the source text that is configured to not be translated and wrapping those parts of the text in control text/tags (e.g., specific html no-translate tags), or other suitable transformations. The MT service 110 may take the credentials and metadata, as mentioned above, and creates a valid API call(s) to that MT service 110 containing that data with the modified source text as input. The MT service 110 may returns a response, where (i) if a non-200 status code HTTP code response (or another suitable response), then continue with a blank translation, or (ii) if a 200 status code HTTP response (or another suitable response), then get (e.g., copy, download) the translation from the response. The MT service 100 may reverse the source text transformations from above, which may include (i) removing control text/tags that are in the translation, (ii) combining the split translation texts into a single translation text (e.g., append), (iii) unescaping (or decoding) the text based on how the source text was escaped (or encoded), or other suitable reversales. The translation from the MT service 110 can be copied to be used downstream, as disclosed herein. For example, as shown below, a SourceText may be sent to the MT service 110 and a TranslationText may be returned, as exemplified below:

| | |
|---|---|
| SourceText | ‘Schedule your First Post’ |
| TranslationText | ‘Programe su primer post’ |

Step 5 involves the computing instance 106 determining whether the translation received from the MT service is valid, i.e., performing validation. If not, then step 6 is performed. If yes, then step 7 is performed. For example, such validation may include determining by the computing instance 106 whether the translation is (e.g., invalid) or is not blank (e.g., valid). As such, For an example presented above, the TranslationText passes such validation.

Step 6 involves the computing instance 106 generating an error or terminating the method 200. For example, the error or such terminating may occur when the call from the API has failed so this workflow exits in an error condition to be handled by the computing instance 106.

Step 7 involves the computing instance 106 filtering terminology terms for missing terms in translation. For example, the translation may be tokenized, as exemplified below.

| | |
|---|---|
| Text | ‘Schedule your First Post’ |
| Tokenized Text | [Schedule, your, First, Post] |

For example, the tokens may then be lemmatized and/or stemmed to reduce every word in the string to their stems, as exemplified below.

| | |
|---|---|
| SourceText | ‘Schedule your First Post’ |
| TranslationText | ‘Programe su primer post’ |
| Tokenized SourceText | [Schedule, your, First, Post] |
| Tokenized TranslationText | [Programe, su, primer, post] |
| Lemmas | [schedule, your, first, post] |
| | [Programar, su, primer, post] |
| Stems | [schedul, your, first, post] |
| | [Program, su, prim, post] |

For example, the glossary terms in the target locale may then be lemmatized and/or stemmed to reduce every word in the string to their stems, as exemplified below.

| | |
|---|---|
| Target Glossary Term | [programar, publicación] |
| Lemmas | [programar, publicación] |
| Stems | [program, public] |

Such filtering may include (i) searching the translation stems to align them with the glossary term stems, such as schedule->programar, post->post, (ii) filtering out all glossary terms whose stems were found in the translation stems, and (iii) return a collection of the missing stems, such as [post].

Step 8 involves the computing instance 106 determining whether there are any missing translation terms. If yes, then step 9 is performed. If no, then step 13 is performed. For example, the computing instance 106 may test to see if the collection of missing stems is empty (Yes path) or not (No path), such as if post->publication is found in the collection, then the collection is not empty.

Step 9 involves the computing instance 106 generating a prompt with missing terms for submission to the LLM 114, whether directly or through the chatbot 112. This action may involve the computing instance 106 generating an input containing a source string (a.k.a. SourceText), an MT-string (a.k.a. TranslationText), and a set of glossary terminology mappings (a.k.a. TermsMap). An example of the prompt may be “prompt”:“Perfect the following translation (Translation: % s) from source (Source: % s) and replace translation terms (but not numerals) in html tags with the following mapping: % s” % (TranslationText, SourceText, TermsMap). The prompt is submitted to the LLM 114, which may be exemplified by below:

| | |
|---|---|
| SourceText | ‘Schedule your First Post’ |
| TranslationText | ‘Programe su primer post’ |
| TermsMap | ‘{Post=publicación, Schedule=programar}’ |
| LLM Output: | ‘Programa tu primera publicación’ |

Step 10 involves the computing instance 106 fetching the translation from the LLM 114 based on the prompt, as modified by the LLM 114 responsive to the prompt. The computing instance 106 may fetch a set of credentials (e.g., login and password) and metadata for the LLM 114 to be able to execute an API call (e.g., a REST API call). For example, this metadata may include a uniform resource identifier (URI) (e.g., “https://api.openai.com/v1/completions”), an API Key or other credentials, a model name (ex. “text-davinci-003”), a timeout configuration, a maximum output token length value, a temperature, an LLM parameter (e.g., top-k, top-p), a frequency penalty identifier, a presence penalty identifier, or other suitable metadata. The computing instance 106 may execute an API call (e.g., a REST API call) into the LLM 114 with the prompt and metadata as an input. The computing instance 106 may transform the results of the API call into the input for step 10. This transformation may include cases where the computing instance 106 receives a 200 response status code and all error cases.

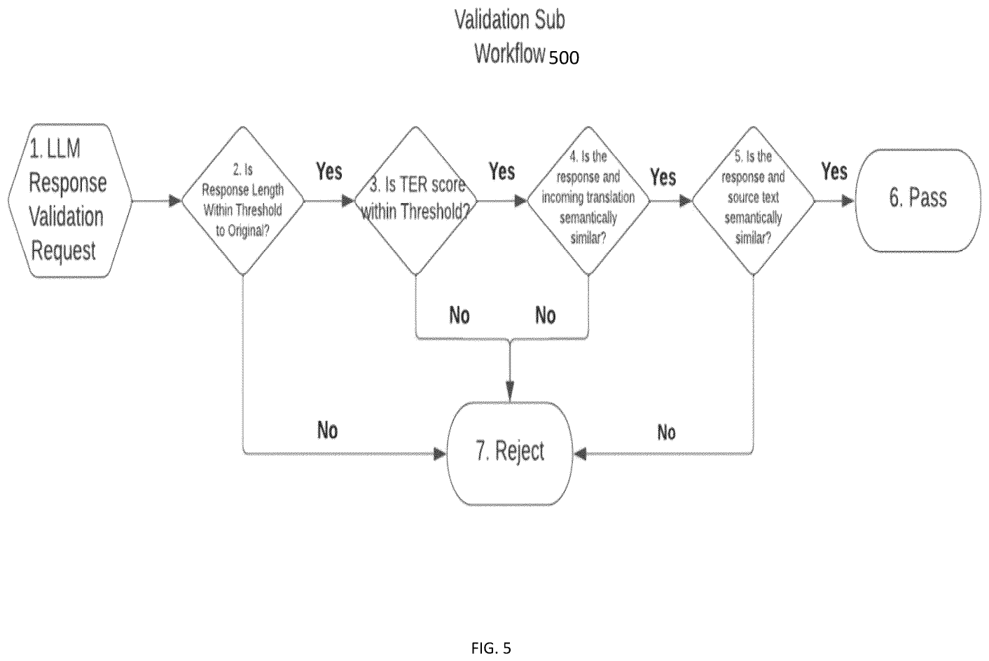

Step 11 involves the computing instance 106 perform validation on the content received from the LLM, which may be post-transformation of step 10. This form of validation can be done in various ways. One example of such validation is disclosed in context of FIG. 5. Regardless of what form of validation is performed, the computing instance 106 generates a validation output, which may be a pass/reject state of whether the input (the content from the LLM) is valid or not. If not, then step 12 is performed. If yes, then step 13 is performed.

Step 12 involves the computing instance 106 reverting to the original translation, received from step 4. If there is a failure to generate a new valid translation from the LLM 114, then the computing instance 106 may proceed using the original translation from the MT service 110.

Step 13 involves the computing instance 106 filtering terminology terms for gendered terms. If there are no glossary terms present, but gendered terms are present OR if glossary terms and gendered terms are both present and the strings went through the glossary flow already, then the computing instance 106 may tokenize the source and target string, as exemplified below.

| | |
|---|---|
| SourceText | ‘President Yacob is a great |
| TranslationText | leader for Singapore.’ |
| | ‘El Presidente Yacob es un gran |
| | líder para Singapur.’ |
| Tokenized SourceText | [President, Yacob, is, a, great, |
| Tokenized TranslationText | leader, for, Singapore.] |
| | [El Presidente, Yacob, es, un, gran, |
| | líder, para, Singapur.] |

The computing instance 106 may then lemmatize the tokens to reduce every word in the source string to their lemmas, as exemplified below.

| | |
|---|---|
| SourceText | ‘President Yacob is a great leader for Singapore.’ |
| TranslationText | ‘El Presidente Yacob es un gran líder para Singapur.’ |
| Tokenized SourceText | [President, Yacob, is, a, great, leader, for, Singapore.] |
| Tokenized | [El Presidente, Yacob, es, un, gran, líder, para, |
| TranslationText | Singapur.] |
| Lemma | [President, Yacob, be, a, great, leader, for, Singapore.] |
| | [El Presidente, Yacob, ser, uno, gran, líder, parir, |
| | Singapur.] |
| Stem | [Presid, Yacob, is, a, great, lead, for, Singapor.] |
| | [El President, Yacob, ser, uno, gran, lid, par, Singapur.] |

The computing instance 106 may find titles and nouns token in source string that need to be properly translated based on gender of individuals mentioned in the string (e.g., doctor, professor, governor, mayor, president, colonel, general), such as ‘President’ in an example shown above. The computing instance 106 may search the translation lemmas to align them with the target term title/noun tokens. For example: [President->El President, Yacob->Yacob, be->ser, a->uno, great->gran, leader->lider, for->parir, Singapore->Singapur]. The computing instance 106 may filter out string if all title/noun terms whose tokens were found in the translation tokens list correspond to their proper gender. The computing instance 106 may return a collection of the tokens associated with the wrong gender, such as [President->El Presidente, a->uno].

Step 14 involves the computing instance 106 determining whether a gendered term present. For example, the computing instance 106 may check to see if the collection of gendered terms contains any values. If yes, then step 15 is performed. If not, then step 19 is performed.

Step 15 involves the computing instance 106 generating a prompt with a gendered term for submission to the LLM 114, whether directly or through the chatbot 112. This action may involve the computing instance 106 generating an input containing a source string (a.k.a. SourceText), an MT-string (a.k.a. TranslationText), a target language identifier (a.k.a. TargetLang), and the gender associated with the titled person in the source string. The prompt is submitted to the LLM 114, which may be exemplified as “prompt”:“The president of Singapore is Halimah Yacob and she is a woman. Given this Source: % s and this Translation:% s, return a grammatically correct translation in % s with a title that reflects her gender.” %(SourceText, TranslationText, TargetLang), as shown below.

| | |
|---|---|
| SourceText | ‘President Yacob is a great leader for Singapore.’ |
| MT-engine output | ‘El Presidente Yacob es un gran líder para Singapur.’ |
| Gender of the | Female |
| Subject | |
| TargetLang | Spanish |
| LLM Output: | ‘La Presidenta Yacob es una gran líder para Singapur.’ |

Step 16 involves the computing instance 106 fetching the translation from the LLM 114 based on the prompt, as modified by the LLM 114 responsive to the prompt. The computing instance 106 may fetch a set of credentials (e.g., login and password) and metadata for the LLM 114 to be able to execute an API call (e.g., a REST API call), or avoid doing so if the computing instance 106 is already signed into the LLM 114, which may be from steps 9-10. For example, this metadata may include a URI (e.g., “https://api.openai.com/v1/completions”), an API Key or other credentials, a model name (ex. “text-davinci-003”), a timeout configuration, a maximum output token length value, a temperature, an LLM parameter (e.g., top-k, top-p), a frequency penalty identifier, a presence penalty identifier, or other suitable metadata. The computing instance 106 may execute an API call (e.g., a REST API) call to the LLM 114 with the prompt and metadata as an input. The computing instance 106 may transform the results of the API call into the input for step 17. This transformation may include cases where the computing instance 106 may receive a 200 response and all error cases.

Step 17 involves the computing instance 106 perform validation on the content received from the LLM, which may be post-transformation of step 16. This form of validation can be done in various ways. One example of such validation is disclosed in context of FIG. 5. Regardless of what form of validation is performed, the computing instance 106 generates a validation output, which may be a pass/reject state of whether the input (the content from the LLM) is valid or not. If not, then step 18 is performed. If yes, then step 19 is performed.

Step 18 involves the computing instance 106 reverting to the previous translation from step 13. If the computing instance 106 failed to generate a new valid translation from the LLM 114, then the computing instance proceeds using the previous translation from step 13.

Step 19 involves the computing instance 106 completing the method 200. At this point, the computing instance 106 may output the translation to the computing terminal 104 responsive to the translation request from step 1, or another data source (e.g., an API), whether internal or external to the computing instance 106. This translation can be consumed (e.g., displayed, printed, shared, messaged, emailed, stored) on the computing terminal 104.

FIG. 5 shows a flowchart of an embodiment of an algorithm for a validation according to this disclosure. In particular, a method 500 enables an algorithm for a validation using the computing architecture 100 of FIG. 1, a data structure 300 for a glossary of FIG. 3, and a hierarchy 400 for a glossary of FIG. 4. The method 200, the method 500, the data structure 300, and the hierarchy 400 collectively improve MTs for proper usage of terminology, gender, or other suitable predetermined linguistics. Such improvements may be manifested by resolution of certain grammar, morphology, or other linguistic issues in MT outputs incorporating specific terminology, such as brand names and gendered terms, as disclosed herein. Resultantly, these improvements improve computer functionality and text processing.

The method 500 has steps 1-7, which may be performed by the computing instance 106 (e.g., an application program). As such, in order to ensure proper replacement of terms, gendered terms, or other suitable linguistics, the computing instance 106 is programmed to grammatically correct and smooth sentences based on information provided and terms, key word, or gender changes, where the computing instance 106 (e.g., an application program) may perform steps 1-7, as further explained below. Note that a green arrow respectfully corresponds to a positive response from a step, while a red arrow respectfully corresponds to a negative response from a step. The method 500 may be called while the method 200 is performed, which may occur at step 11 or step 17, as explained above. The method 500 returns a pass/reject state of whether the input is valid or not.

Step 1 involves the computing instance 106 initiates validation of the response from the LLM 114. This initiation includes an input containing (i) the source text (the input text to be translated), (ii) the source locale ID, which may include the modified ISO-639 (or another standard) language code and the modified ISO-3166 (or another standard) country code representing the source text locale, (iii) the target local ID, which may include the modified ISO-639 (or another standard) language code and the modified ISO-3166 (or another standard) country code representing the desired locale to use for the translation, (iv) the translation text (the latest translation text), and (v) the previous translation text (the translation text before the new translation text was generated).

Step 2 involves the computing instance 106 determines whether the response length is within a set threshold to original text. For example, the computing instance 106 determines whether the response string length within a set threshold of the original string (e.g., within 10% of the original string). Note that blank strings may fail. If yes, then step is performed. If not, then step 7 is performed.

Step 3 involves the computing instance 106 determines whether a translation error rate score is within a set threshold (e.g., 10% within the length of the glossary terms difference in characters between the MT and the string returned from LLM 114). If yes, then step 4 is performed. If not, then step 7 is performed.

Step 4 involves the computing instance 106 determines whether the response and incoming translation are semantically similar to each other. The computing instance 106 may convert the translation text and previous translation text into vector embeddings and calculate their cosine similarities to find their semantic similarities, such as whether the cosine similarity is within or above or below a threshold range (e.g., above 70%). If yes, then step 5 is performed. If not, then step 7 is performed.

Step 5 involves the computing instance 106 determines whether the response and the source text are semantically similar to each other. The computing instance 106 may convert the translation text and the source text into vector embeddings and calculate their cosine similarities to find their semantic similarities, such as whether the cosine similarity is within or above or below a threshold range (e.g., above 70%). If yes, then step 6 is performed. If no, then step 7 is performed.

Step 6 involves the computing instance 106 outputting a pass code or state

Step 7 involves the computing instance 106 outputting a fail code or state.

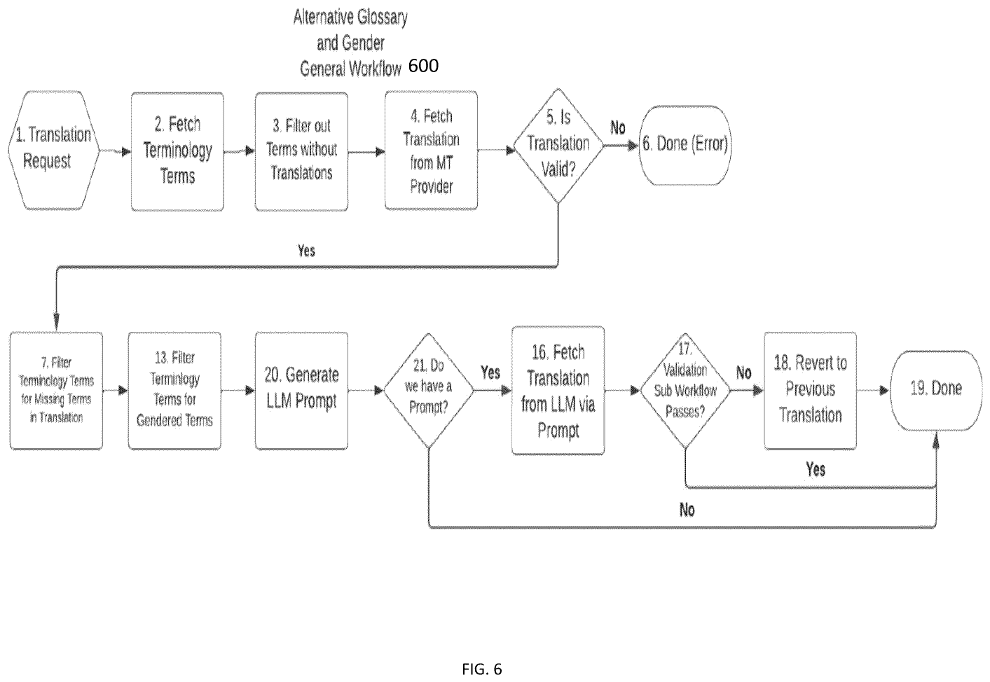

FIG. 6 shows a flowchart of an embodiment of an algorithm for a translation according to this disclosure. In particular, there is a method 600, which is similar to the method 200. However, unlike the method 200, the method 600 omits steps 8-12 and 14-15, includes steps 20-21, and inserts steps 20-21 between step 13 and step 16, with everything else remaining identical to the method 200, i.e., the method 600 combines the Missing Translation Terms logic and the Gender Terms logic into a single prompt into the LLM 114.

Step 20 involves the computing instance 106 generating a prompt for submission to the LLM 114. This generation may occur by the computing instance 106 combining the collection of missing terms and the gendered terms into a single prompt. If both collections are determined by the computing instance 106 to have terms, then the computing instance 106 creates a single prompt with all terms to do both transformations. If only the collection of missing terms is determined by the computing instance 106 to have entries, then the prompt generated by the computing instance 106 will correct the terms but not gender. If only the collection of gendered terms is determined by the computing instance 106 to have entries, then the prompt generated by the computing instance 106 will correct gender but not attempt to replace terms. If both collections are determined by the computing instance 106 to be empty, then no prompt is created by the computing instance 106.

Step 21 involves the computing instance 106 determining whether there is a prompt. The computing instance 106 checks if a prompt for the LLM 114 was created, and if so, then the computing instance 106 continues. If not, then the method 600 is terminated.

Based on the method 200 or the method 500, the computing instance 106 may be programmed to: (i) submit the source text to the MT service 110, such that the MT service 110 outputs the target text translated from the source text, as per step 4; (ii) determine whether the target text satisfies a condition, as per step 5; (iii) determine whether a first term is not present in the target text, responsive to the condition being determined to be satisfied, as per step 8; (iv) submit the first term and the target text to the LLM 114, such that the LLM 114 outputs the target text modified to contain the first term, responsive to the first term being determined to be not present in the target text, as per steps 9-10; (v) determine whether a second term is present in the target text (a) unmodified in content as output from the MT service 110 or (b) modified via the LLM 114 to contain the first term, as per step 14; and (vi) submit the second term and the target text (a) unmodified in content as output from the MT service 110 or (b) modified via the LLM 114 to contain the first term to the LLM 114, such that the LLM 114 outputs the target text (a) unmodified in content as output from the MT service 110 or (b) modified via the LLM 114 to contain the first term, modified to contain the second term in a grammatically correct manner or a morphologically correct manner, responsive to the second term being determined to be present in the target text (a) unmodified in content as output from the MT service 110 or (b) modified via the LLM 114 to contain the first term, as per steps 15-16. The MT service 110 may internal or external to the computing instance 106. The LLM 114 may be internal or external to the computing instance 106. The first term and the target text may be submitted to the LLM 114 through a chatbot application, which may be internal or external to the computing instance 106. The second term and the target text (a) unmodified in content as output from the MT service 110 or (b) modified via the LLM 114 to contain the first term may be submitted to the LLM 114 through the chatbot application 112, which may be internal or external to the computing instance 106. The second term may be determined to be present in the target text unmodified in content as output from the MT service 110. The second term may be determined to be present in the target text modified via the LLM 114 to contain the first term. The second term and the target text unmodified in content as output from the MT service 110 may be submitted to the LLM 114. The second term and the target text modified via the LLM 114 to contain the first term may be submitted to the LLM 114. The condition may be indicative of the target text being valid, which may be based on the target text not being blank. The computing instance 106 may be programmed to output an error message when the condition is indicative of the target text not being valid based on the target text being blank. The source text may be recited in a source language, the target text may be recited in a target language, and the first term may be a stem missing from a glossary related to the source language and the target language. The glossary may be internal or external to the computing instance 106. The second term may be a gendered term. The computing instance 106 may be programmed to enable an output of the target text (a) unmodified in content as output from the MT service 110 or (b) modified via the LLM 114 to contain the first term for consumption on the computing terminal 104, responsive to the second term being determined to be not present in the target text (a) unmodified in content as output from the MT service 110 or (b) modified via the LLM 114 to contain the first term. The target text may be unmodified in content as output from the MT service 110. The target text may be modified via the LLM 114 to contain the first term. The computing instance 106 may be programmed to: perform a validation of the target text (a) unmodified in content as output from the MT service 110 or (b) modified via the LLM 114 to contain the first term, modified to contain the second term in the grammatically correct manner or the morphologically correct manner; based on the validation passing: enable an output of the target text (a) unmodified in content as output from the MT service 110 or (b) modified via the LLM 114 to contain the first term, modified to contain the second term in the grammatically correct manner or the morphologically correct manner for consumption on the computing terminal 104; based on the validation failing: revert to the target text (a) unmodified in content as output from the MT service 110 or (b) modified via the LLM 114 to contain the first term; and enable a presentation of the target text (a) unmodified in content as output from the MT service 110 or (b) modified via the LLM 114 to contain the first term on the computing terminal 104. The validation may be performed based on a length of the target text (a) unmodified in content as output from the MT service 110 or (b) modified via the LLM 114 to contain the first term, modified to contain the second term in the grammatically correct manner or the morphologically correct manner. The validation may be performed based on a translation error rate of the target text (a) unmodified in content as output from the MT service 110 or (b) modified via the LLM 114 to contain the first term, modified to contain the second term in the grammatically correct manner or the morphologically correct manner. The validation may be performed based on a semantic similarity between the target text (a) unmodified in content as output from the MT service 110 or (b) modified via the LLM 114 to contain the first term, modified to contain the second term in the grammatically correct manner or the morphologically correct manner and the target text (a) unmodified in content as output from the MT service 110 or (b) modified via the LLM 114 to contain the first term. The validation may be performed based on a semantic similarity between the target text (a) unmodified in content as output from the MT service 110 or (b) modified via the LLM 114 to contain the first term, modified to contain the second term in the grammatically correct manner or the morphologically correct manner and the source text. The validation may be performed on the target text unmodified in content as output from the MT service 110, modified to contain the second term in the grammatically correct manner or the morphologically correct manner. The validation may be performed on the target text modified via the LLM 114 to contain the first term, modified to contain the second term in the grammatically correct manner or the morphologically correct manner. The computing instance 106 may be programmed to: generate a prompt referencing the target text and the first term, responsive to the first term being determined to be not present in the target text; submit the prompt to the LLM 114, such that the LLM 114 outputs the target text modified to contain the first term; perform a validation of the target text modified to contain the first term; based on the validation passing: determine whether the second term is present in the target text (a) unmodified in content as output from the MT service 110 or (b) modified via the LLM 114 to contain the first term; and based on the validation failing: determine whether the second term is present in the target text unmodified in content as output from the MT service 110. The source text may be an unstructured text or a structured text. The target text may be an unstructured text or a structured text. Similar programming may of the computing instance 106 may enable a method do operate the computing instance 106, as per foregoing, or a storage medium (e.g., a memory, a persistent memory) storing a set of instructions executable by the computing instance 106 to perform the method, as per foregoing.

Based on the method 600 or the method 500, the computing instance 106 may be programmed to: (i) submit the source text to the MT service 110, such that the MT service 110 outputs the target text translated from the source text, as per step 4; (ii) determine whether the target text satisfies a condition, as per step 5; (iii) determine whether the target text lacks a first term and has a second term, responsive to the condition being determined to be satisfied, as per steps 7 and 13; (iv) based on the target text being determined to lack the first term and have the second term: generate a prompt reciting the first term and the second term, as per step 20; and submit the prompt to the LLM 114, such that the LLM 114 outputs a modification of the target text to include the first term and the second term in a grammatically correct manner or a morphologically correct manner, as per step 16. The MT service 110 may be internal or external to the computing instance 106. The LLM may be internal or external to the computing instance 106. The prompt may be submitted to the LLM 114 via the chatbot 112, which may be internal or external to the computing instance 106. The computing instance 106 may be programmed to: perform a validation of the target text modified via the LLM 114 to contain the first term and the second term in the grammatically correct manner or the morphologically correct manner; based on the validation passing: enable an output of the target text modified via the LLM 114 to contain the first term and the second term in the grammatically correct manner or the morphologically correct manner for consumption on the computing terminal 104; based on the validation failing: revert to the target text unmodified in content as output from the MT service 110; and enable a presentation of the target text unmodified in content as output from the MT service 110 on the computing terminal 104. The source text may be an unstructured text or a structured text. The target text may be an unstructured text or a structured text. Similar programming may of the computing instance 106 may enable a method do operate the computing instance 106, as per foregoing, or a storage medium (e.g., a memory, a persistent memory) storing a set of instructions executable by the computing instance 106 to perform the method, as per foregoing. Other subject matter from the method 200 can be performed as well, as explained above.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening 1/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

This disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, a chemical molecule, a chemical composition, or any suitable combination or equivalent of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although various embodiments have been depicted and described in detail herein, skilled artisans know that various modifications, additions, substitutions and the like can be made without departing from this disclosure. As such, these modifications, additions, substitutions and the like are considered to be within this disclosure.

What is claimed is:

1. A system, comprising:
a computing instance programmed to:
(i) submit a source text to a network-based machine translation (MT) service, such that the network-based MT service outputs a target text translated from the source text;
(ii) determine whether the target text satisfies a condition;
(iii) determine whether a first term is not present in the target text, responsive to the condition being determined to be satisfied;
(iv) submit the first term and the target text to a large language model (LLM), such that the LLM outputs the target text modified to contain the first term, responsive to the first term being determined to be not present in the target text;
(v) determine whether a second term is present in the target text (a) unmodified in content as output from the network-based MT service or (b) modified via the LLM to contain the first term; and
(vi) submit the second term and the target text (a) unmodified in content as output from the network-based MT service or (b) modified via the LLM to contain the first term to the LLM, such that the LLM outputs the target text (a) unmodified in content as output from the network-based MT service or (b) modified via the LLM to contain the first term, modified to contain the second term in a grammatically correct manner or a morphologically correct manner, responsive to the second term being determined to be present in the target text (a) unmodified in content as output from the network-based MT service or (b) modified via the LLM to contain the first term.

2. The system of claim 1, wherein the second term and the target text (a) unmodified in content as output from the network-based MT service or (b) modified via the LLM to contain the first term are submitted to the LLM through a chatbot application.

3. The system of claim 1, wherein the second term is determined to be present in the target text unmodified in content as output from the network-based MT service.

4. The system of claim 1, wherein the second term is determined to be present in the target text modified via the LLM to contain the first term.

5. The system of claim 1, wherein the second term and the target text unmodified in content as output from the network-based MT service are submitted to the LLM.

6. The system of claim 1, wherein the second term and the target text modified via the LLM to contain the first term are submitted to the LLM.

7. The system of claim 1, wherein the source text is recited in a source language, wherein the target text is recited in a target language, wherein the first term is a stem missing from a glossary related to the source language and the target language.

8. The system of claim 1, wherein the second term is a gendered term.

9. The system of claim 1, wherein the computing instance is programmed to enable an output of the target text (a) unmodified in content as output from the network-based MT service or (b) modified via the LLM to contain the first term for consumption on a computing terminal, responsive to the second term being determined to be not present in the target text (a) unmodified in content as output from the network-based MT service or (b) modified via the LLM to contain the first term.

10. The system of claim 9, wherein the target text is unmodified in content as output from the network-based MT service.

11. The system of claim 9, wherein the target text is modified via the LLM to contain the first term.

12. The system of claim 1, wherein the computing instance is programmed to:
perform a validation of the target text (a) unmodified in content as output from the network-based MT service or (b) modified via the LLM to contain the first term, modified to contain the second term in the grammatically correct manner or the morphologically correct manner;
based on the validation passing:
enable an output of the target text (a) unmodified in content as output from the network-based MT service or (b) modified via the LLM to contain the first term, modified to contain the second term in the grammatically correct manner or the morphologically correct manner for consumption on a computing terminal;
based on the validation failing:
revert to the target text (a) unmodified in content as output from the network-based MT service or (b) modified via the LLM to contain the first term; and
enable a presentation of the target text (a) unmodified in content as output from the network-based MT service or (b) modified via the LLM to contain the first term on the computing terminal.

13. The system of claim 12, wherein the validation is performed based on a length of the target text (a) unmodified in content as output from the network-based MT service or (b) modified via the LLM to contain the first term, modified to contain the second term in the grammatically correct manner or the morphologically correct manner.

14. The system of claim 12, wherein the validation is performed based on a translation error rate of the target text (a) unmodified in content as output from the network-based MT service or (b) modified via the LLM to contain the first term, modified to contain the second term in the grammatically correct manner or the morphologically correct manner.

15. The system of claim 12, wherein the validation is performed based on a semantic similarity between the target text (a) unmodified in content as output from the network-based MT service or (b) modified via the LLM to contain the first term, modified to contain the second term in the grammatically correct manner or the morphologically correct manner and the target text (a) unmodified in content as output from the network-based MT service or (b) modified via the LLM to contain the first term.

16. The system of claim 12, wherein the validation is performed based on a semantic similarity between the target text (a) unmodified in content as output from the network-based MT service or (b) modified via the LLM to contain the first term, modified to contain the second term in the grammatically correct manner or the morphologically correct manner and the source text.

17. The system of claim 12, wherein the validation is performed on the target text unmodified in content as output from the network-based MT service, modified to contain the second term in the grammatically correct manner or the morphologically correct manner.

18. The system of claim 12, wherein the validation is performed on the target text modified via the LLM to contain the first term, modified to contain the second term in the grammatically correct manner or the morphologically correct manner.

19. The system of claim 1, wherein the computing instance is programmed to:
generate a prompt referencing the target text and the first term, responsive to the first term being determined to be not present in the target text;
submit the prompt to the LLM, such that the LLM outputs the target text modified to contain the first term;
perform a validation of the target text modified to contain the first term;
based on the validation passing:
determine whether the second term is present in the target text (a) unmodified in content as output from the network-based MT service or (b) modified via the LLM to contain the first term; and
based on the validation failing:
determine whether the second term is present in the target text unmodified in content as output from the network-based MT service.

20. A system, comprising:
a computing instance programmed to:
(i) submit a source text to a network-based machine translation (MT) service, such that the network-based MT service outputs a target text translated from the source text;
(ii) determine whether the target text satisfies a condition;
(iii) determine whether the target text lacks a first term and has a second term, responsive to the condition being determined to be satisfied;
(iv) based on the target text being determined to lack the first term and have the second term:
generate a prompt reciting the first term and the second term; and
submit the prompt to a large language model (LLM), such that the LLM outputs a modification of the target text to include the first term and the second term in a grammatically correct manner or a morphologically correct manner.

21. The system of claim 20, wherein the computing instance is programmed to:
perform a validation of the target text modified via the LLM to contain the first term and the second term in the grammatically correct manner or the morphologically correct manner;
based on the validation passing:
enable an output of the target text modified via the LLM to contain the first term and the second term in the grammatically correct manner or the morphologically correct manner for consumption on a computing terminal;
based on the validation failing:
revert to the target text unmodified in content as output from the network-based MT service; and
enable a presentation of the target text unmodified in content as output from the network-based MT service on the computing terminal.
